(19) United States
(12) Patent Application Publication
(10) Pub. No.: US 2005/0020290 A1
(43) Pub. Date: Jan. 27, 2005

(54) Communication system, and base station and mobile station which are used for the same

(76) Inventors: Koji Arata, Yokohama-shi (JP); Masanori Maruoka, Yokohama-shi (JP); Akihisa Kawasaki, Sagamihara-shi (JP)

Correspondence Address: RATNERPRESTIA, P O BOX 980, VALLEY FORGE, PA, 19482-0980, US

(21) Appl. No.: 10/895,698

(22) Filed: Jul. 21, 2004

(30) Foreign Application Priority Data
Jul. 23, 2003 (JP) 2003-278082
Aug. 6, 2003 (JP) 2003-287565
Jul. 9, 2004 (JP) 2004-202879

(51) Int. Cl. H04H 1/00

(52) U.S. Cl. 455/500; 455/3.05

(57) ABSTRACT

A data processing section of a base station communication apparatus monitors a data transfer state of an application data transfer section and judges whether there is a necessity of two-way communication. If there is no necessity of two-way communication, then a transmission inquiry interval is lengthened or stopped.

### FIELD OF THE INVENTION

This invention relates to a communication system between a base station and a mobile station, and a base station and a mobile station which are used for this, and in particular, relates to a communication system and a base station, a mobile station which carry out broadcast communication and two-way communication.

### BACKGROUND OF THE INVENTION

In the past, as a this type of a communication system, for example, there was a thing which is described in an article entitled “5.8G_DSRC APPLICATION SUB-LAYER DETAILED TECHNICAL MATERIAL (PROPOSAL)” Vol. No. 0.70, published by Highway Industry Development Organization, on March, 2003, P. 3-21 to 3-27. A conventional communication system has an assumption that communication is carried out by a configuration of a communication processing section having a plurality of applications, a plurality of data processing sections which correspond to the applications, and a two-way communication function and a broadcast communication function, and in case that data processing sections of a mobile station and a base station are not matched at all, link establishment is not carried out.

Therefore, in case that even only one of data processing sections of the mobile station and the base station was matched, for the purpose of two-way data transmission and reception after the link establishment, repeated is such a transmission inquiry that a message of a transmission inquiry is sent from the base station to the mobile station, and a message of a transmission inquiry response is sent from the mobile station to the base station.

On one hand, in case of the broadcast communication, regardless of the above-described transmission inquiry, data transmission is independently repeated from the base station to the mobile station, without a response from the mobile station.

However, in the suchlike conventional communication system, in case that even only one of data processing sections of a mobile station and a base station is matched, even if an application between the base station and the mobile station is finished and actual data transmission and reception is not carried out by applications between both stations, a transmission inquiry from the base station to the mobile station is carried out repeatedly by a two-way communication function of the communication processing section.

Therefore, there was such a problem that, regardless of such a fact that an application is finished, a communication band is occupied uselessly by the transmission inquiry, and a communication band of broadcast communication, and a communication band between the base station and another mobile station are suppressed, so that it takes time for communication. In case that the mobile station is, for example, a vehicle, the suchlike problem became such a big problem that, the more vehicles are increased, the more it takes time for communication in respective vehicles.

Also, even if there exist a mobile station which operates an application with lower importance as compares to others, and a mobile station which operates an application with higher importance, a transmission inquiry is carried out regardless of a level of importance.

Also, even after an application between a base station and a mobile station was finished, since each does not have a unit which restricts a transmission inquiry, an inquiry is continued even in case that there is no necessity of communication.

By the above-described reasons, there was such a problem that a communication band of broadcast communication, and a communication band between a base station and another mobile station are consumed uselessly.

### SUMMARY OF THE INVENTION

The invention was made to solve the suchlike conventional problem, and aims to provide a communication system and a base station, a mobile station, in which there occurs no case that a communication band is occupied by a transmission inquiry function for two-way communication in which an application was finished, which can secure a communication band of broadcast communication, and a communication band between a base station and another mobile station, and in which there occurs no case to uselessly consume the communication band of broadcast communication, and the communication band between the base station and another mobile station.

A communication system of the invention has a configuration having a broadcast communication unit adapted to transmit data in a single direction from a base station to a mobile station, a two-way communication unit adapted for the mobile station to transmit data to the base station in accordance with at least one time transmission inquiry request from the base station to the mobile station, a judgment unit disposed in the base station or the mobile station and adapted to judge whether or not the two-way communication is carried out continuously, and a restriction unit adapted to restrict a transmission inquiry request from the base station to the mobile station, in case that the judgment unit judged that there is no necessity to continuously carry out the two-way communication.

By this configuration, on the basis of such a judgment that there is no necessity to continuously carry out two-way communication at a base station or a mobile station, it is possible to restrict a transmission inquiry request from the base station to the mobile station.

Also, a communication system of the invention has such a configuration that restriction of the transmission inquiry request from the base station to the mobile station by the restriction unit is carried out in case that, in such a state that the broadcast communication is continued, it was further judged that there is no necessity to continuously carry out the two-way communication.

By this configuration, under such a state that broadcast communication and two-way communication exist together, on the basis of such a judgment that there is no necessity to continuously carry out two-way communication at a base station or a mobile station, it is possible to restrict a transmission inquiry request from the base station to the mobile station.

Also, a communication system of the invention has such a configuration that restriction of the transmission inquiry request from the base station to the mobile station by the restriction unit is restriction of the number of times as to the transmission inquiry request from the base station to the mobile station.

By this configuration, restriction of the transmission inquiry request from the base station to the mobile station is carried out by restriction of the number of times as to the transmission inquiry request from the base station to the mobile station.

Also, a communication system of the invention has such a configuration that restriction of the transmission inquiry request from the base station to the mobile station by the restriction unit is a stop of the transmission inquiry request from the base station to the mobile station.

By this configuration, restriction of the transmission inquiry request from the base station to the mobile station is carried out by a stop of the transmission inquiry request from the base station to the mobile station.

Also, a communication system of the invention has such a configuration that restriction of the transmission inquiry request from the base station to the mobile station by the restriction unit is judged by the base station or the mobile station on the basis of a type of an application for processing the data.

By this configuration, the base station or the mobile station can judge restriction of the transmission inquiry request from the base station to the mobile station, on the basis of a type of an application for processing the data.

Also, a communication system of the invention has such a configuration that restriction of the transmission inquiry request from the base station to the mobile station by the restriction unit is judged by the base station or the mobile station in accordance with an amount of the data to be processed.

By this configuration, the base station or the mobile station can judge restriction of the transmission inquiry request from the base station to the mobile station, on the basis of an amount of the data to be processed.

Also, a communication system of the invention has such a configuration that the above-described broadcast communication and the above-described two-way communication are carried out by a time division communication system.

By this configuration, it is possible to restrict the transmission inquiry request from the base station to the mobile station, in such a state that the broadcast communication and the two-way communication are carried out by a time division multiplex communication system.

Also, a communication system of the invention has such a configuration that, in case that at least any one of the broadcast communication and the two-way communication is carried out, restriction of the transmission inquiry request from the base station to the mobile station is carried out by the restriction unit.

By this configuration, in case that at least any one of the broadcast communication and the two-way communication is carried out, it is possible to restrict the transmission inquiry request from the base station to the mobile station.

Also, a communication system of the invention has such a configuration that restriction of the transmission inquiry request from the base station to the mobile station by the restriction means in case that the two-way communication is carried out is restriction of the number of times as to the transmission inquiry request from the base station to the mobile station.

By this configuration, restriction of the transmission inquiry request from the base station to the mobile station by the restriction means in case that the two-way communication is carried out can be carried out by restriction of the number of times as to the transmission inquiry request from the base station to the mobile station.

Further, a base station of the invention is a base station communicating with a mobile station through broadcast communication and two-way communication, and has a configuration having a two-way communication unit adapted to transmit data to the mobile station, to which the mobile station can transmit the data in accordance with a transmission inquiry request, a broadcast communication unit adapted to carry out broadcast communication with the mobile station, and a two-way communication restriction unit adapted to restrict the transmission inquiry request to the mobile station, on the basis of such a judgment in the base station or the mobile station that there is no necessity to continuously carry out the two-way communication.

By this configuration, on the basis of such a judgment at the base station or the mobile station that there is no necessity to continuously carry out the two-way communication, it is possible to restrict the transmission inquiry request to the mobile station.

Also further, a mobile station of the invention is a mobile station communicating with a base station through broadcast communication or two-way communication, and has a configuration having a two-way communication unit which can transmit data to the base station in accordance with a transmission inquiry request from the base station, a broadcast communication unit adapted to carry out broadcast communication with the base station, and a judgment unit adapted to carry out a judgment of whether or not the two-way communication is carried out continuously, wherein the two-way communication unit transmits a request for restricting the transmission inquiry request to the base station, in case that the judgment unit judged that there is no necessity to continuously carry out the two-way communication, and the base station restricts the two-way communication on the basis of the request for restricting the transmission inquiry.

By this configuration, in case that the judgment unit judged that there is no necessity to continuously carry out the two-way communication, the two-way communication unit transmits a request for restricting the transmission inquiry to the base station, and on the basis of the request for restricting the transmission inquiry, the base station can restrict the two-way communication.

### BRIEF DESCRIPTION OF THE DRAWINGS

FIG. 1 is a schematic block diagram of a communication system in one embodiment of the invention;

FIG. 2 is a block diagram of a base station communication apparatus of the communication system in one embodiment of the invention;

FIG. 3 is a mobile station communication apparatus of the communication system in one embodiment of the invention;

FIG. 4 is a flow chart for operational description of the communication system in one embodiment of the invention;

FIG. 5 is a flow chart for another operational description of the communication system in one embodiment of the invention;

FIG. 6 is a flow chart for additional operational description of the communication system in one embodiment of the invention;

FIG. 7 is a block diagram of a base station communication apparatus of a communication system in another embodiment of the invention;

FIG. 8 is a block diagram of a mobile station communication apparatus of the communication system in another embodiment of the invention;

FIG. 9 is a flow chart for operational description of the communication system in another embodiment of the invention; and

FIG. 10 is a flow chart for another operational description of the communication system in another embodiment of the invention.

### DESCRIPTION OF THE EXEMPLARY EMBODIMENT

Exemplary embodiments of the present invention are demonstrated hereafter with reference to the accompanying drawings.

1. First Exemplary Embodiment

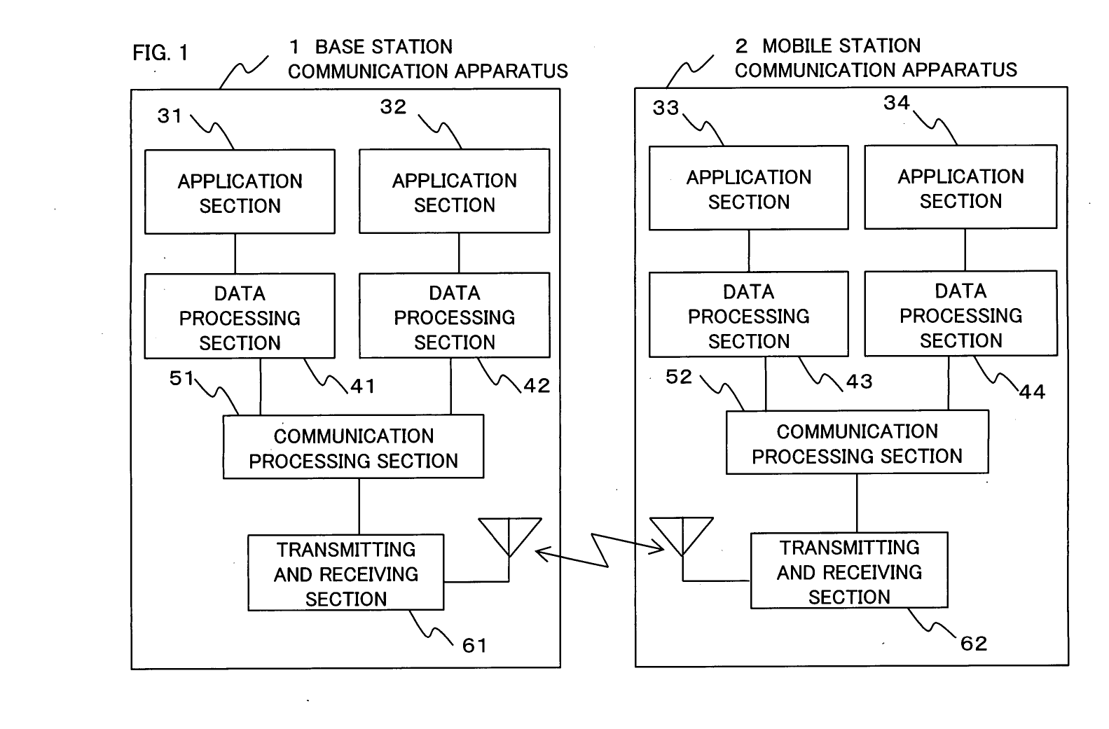

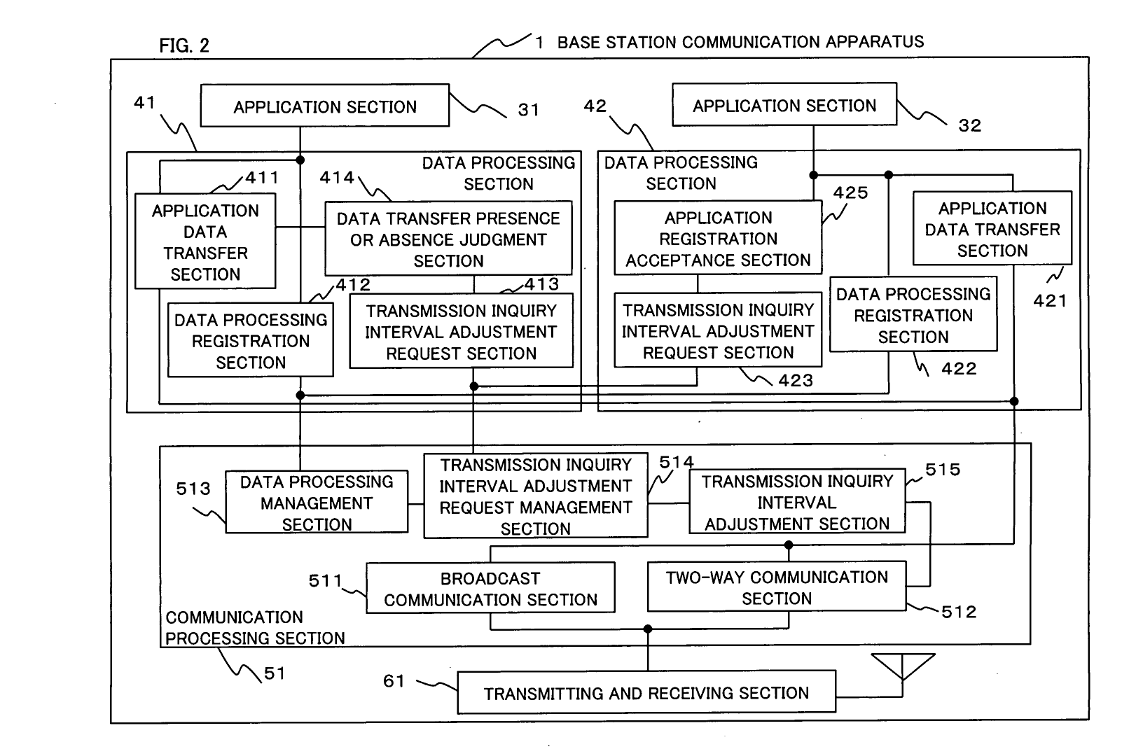

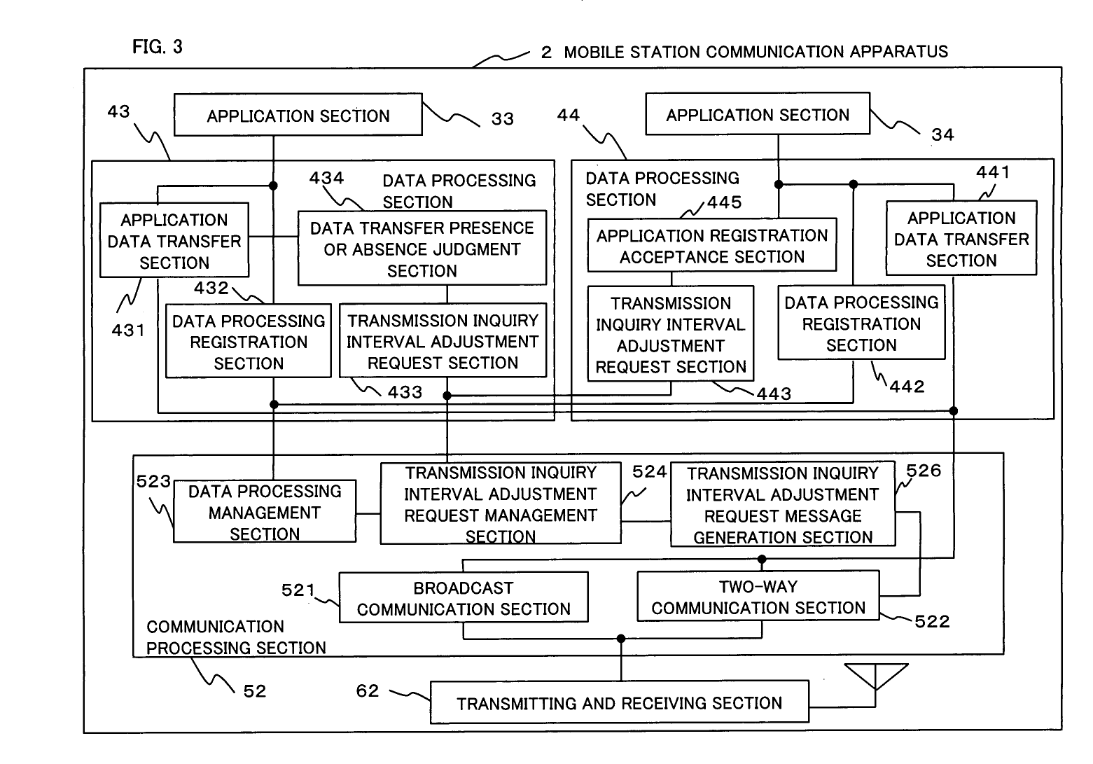

A block diagram of a communication system in one embodiment of the invention is shown in FIG. 1, and a block diagram of a base station communication apparatus of the same embodiment is shown in FIG. 2, and a block diagram of a mobile station communication apparatus of the same embodiment is shown in FIG. 3.

In FIG. 1, the communication system of this embodiment includes a base station communication apparatus 1 and a mobile station communication apparatus 2, and the base station communication apparatus 1 has a plurality of application sections 31, 32, data processing sections 41, 42 which carry out data transfer with these application sections 31, 32, a communication processing section 51 which carries out data transfer with the data processing sections 41,42, and a transmitting and receiving section 61 which carries out data transmission and data reception between the communication processing section 51 and the mobile station communication apparatus 2.

On one hand, the mobile station communication apparatus 2 has a plurality of application sections 33, 34, data processing sections 43, 44 which carry out data transfer with these application sections 33, 34, a communication processing section 52 which carries out data transfer with the data processing sections 43, 44, and a transmitting and receiving section 62 which carries out data transmission and data reception between the communication processing section 52 and the base station communication apparatus 1.

In this embodiment, explanation will be carried out on such assumption that there exist two kinds of application sections with respect to each of the base station communication apparatus 1 and the mobile station communication apparatus 2, respectively, and the data processing sections 41-44, which each application section requests, are different from each other, respectively, and for example, the IP series application sections 31, 33 correspond to the data processing sections 41, 43, respectively, and the non-IP series application sections 32, 34 correspond to the data processing sections 42, 44, respectively.

In passing, as is obvious, the number of the application sections 31-34 is not limited to 2 sets, and there may exist a number of sets. Also, it is not likely to require the data processing sections 41-44 individually with respect to each of the application sections 31-34, and for example, one set of the data processing sections 41, 43 may correspond to a plurality sets of the application sections 31, 32 and 33, 34.

In this embodiment, for example, the application section 31 transmits data to the application section 33 of another station by outputting data to the data processing section 41, and receives data from the application section 33 of another station by accepting data from the data processing section 41. Also, existence of the application section 31 is registered to the data processing section 41. The suchlike operation, data exchange and so on are also the same in other application sections 32-34 and the data processing sections 42-44.

The data processing section 41 of the base station communication apparatus 1 is composed of the following configuration as shown in FIG. 2.

An application data transfer section 411 which transfer IP series data from the application section 31 to a broadcast communication section 511 or a two-way communication section 512 of the communication processing section 51, and transfer data from the two-way communication section 512 of the communication processing section 51 to the application section 31.

A data transfer presence or absence judgment section 414 which judges presence or absence of transfer of data which is transmitted and received between the application section 31 and the broadcast communication section 511 or the two-way communication section 512 of the communication processing section 51, by monitoring data passing through the application data transfer section 411, and which transfer a judgment result to a transmission inquiry interval adjustment request section 413.

A transmission inquiry interval adjustment request section 413 which request adjustment of a transmission inquiry interval, to a transmission inquiry interval adjustment request management section 514 of the communication processing section 51, on the basis of the judgment result of the data transfer presence or absence judgment section 414.

A data processing section registration section 412 which registers existence of the data processing section 41 in a data processing section management section 513 of the communication processing section 51.

Also, the data processing section 42 of the base station communication apparatus 1 is composed of the following configuration as shown in FIG. 2.

An application registration acceptance section 425 which accepts a registration from the non-IP series application section 32, and monitors a type, a function etc. of the application section 32.

A transmission inquiry interval adjustment request section 423 which request adjustment of a transmission inquiry interval, to the transmission inquiry interval adjustment request management section 514 of the communication processing section 51, in case that a non-IP series application, which was registered in the application acceptance registration section 425, is of such a type that transmission of data is not carried out frequently.

An application data transfer section 421 and a data processing section registration section 422 which have the same functions as those of the application data transfer section 411 and the data processing section registration section 412 of the data processing section 41.

Also, the communication processing section 51 of the base station communication apparatus 1 is composed of the following configuration as shown in FIG. 2.

A broadcast communication section 511 which broadcasts each data of the application sections 31, 32, which is transferred from each application data transfer section 411, 421 of the data processing sections 41, 42, to the mobile station communication apparatus 2 through the transmitting and receiving section 61.

A two-way communication section 512 which communicates, in a two-way manner, each data of the application sections 31, 32, to the mobile station communication apparatus 2 through the transmitting and receiving section 61, in the same manner.

A data processing section management section 513 which is connected to the data processing section registration section 412, 422, and which takes hold of existence of the data processing sections 41, 42.

A transmission inquiry interval adjustment request management section 514 which judges a content of adjustment of a transmission inquiry interval, which is carried out to a mobile station for carrying out two-way communication, on the basis of a request from the transmission inquiry interval adjustment request sections 413, 423 of the data processing sections 41, 42 or a request from the mobile station communication apparatus 2.

A transmission inquiry interval adjustment section 515 which carries out a transmission inquiry to the mobile station communication apparatus 2 at a transmission inquiry interval which was determined on the basis of the judgment result in the transmission inquiry interval adjustment request management section 514.

On one hand, the data processing sections 43 and 44 of the mobile station communication apparatus 2 have the same configurations as the data processing sections 41 and 42 of the base station communication apparatus 1 as shown in FIG. 3.

Also, the communication section 52 of the mobile station communication apparatus 2 is composed of the following configuration as shown in FIG. 3.

With regard to a broadcast communication section 521, a two-way communication section 522, a data processing section management section 523, and a transmission inquiry interval adjustment request management section 524, they are of the same configurations as the broadcast communication section 511, the two-way communication section 512, the data processing section management section 513, and the transmission inquiry interval adjustment request management section 514 of the base station communication apparatus 1, respectively.

In addition to these, provided is a transmission inquiry interval adjustment request message generation section 526 which generates and transmits a message for requesting adjustment of a transmission inquiry interval, to the base station communication apparatus 1, in case that the transmission inquiry interval adjustment request management section 524 judged that adjustment of a transmission inquiry interval is necessary.

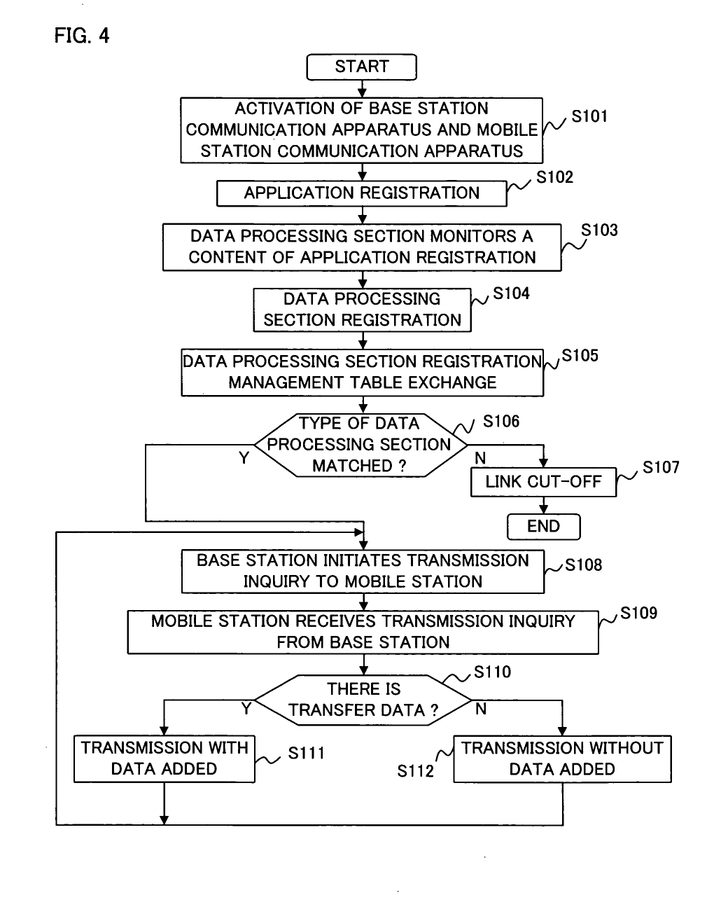

The communication system of this embodiment, which was configured as above, will be described as to its operation, by use of FIGS. 4 through 6 which show its operation flows.

Firstly, in FIG. 4, a power supply is turned ON and so on, so that the base station communication apparatus 1 and the mobile station communication apparatus 2 are activated (S101).

A content (type, function etc.) of an application is sent from the non-IP series application sections 32, 34 of the base station communication apparatus 1 and the mobile station communication apparatus 2 to the application registration acceptance sections 425, 445 of the data processing sections 42, 44 and so on, so that a registration of the application is carried out (S102).

The application registration acceptance sections 425, 445 of the data processing sections 42, 44 monitor a registration content of each application (S103).

In case that the registered application is of such a content that two-way communication is not carried out, its content is notified to the transmission inquiry interval adjustment request management sections 514, 524 of the communication processing sections 51, 52. Further, registrations of the data processing sections 41-44 are carried out from the data processing section 41-44 to the data processing management sections 513, 523 of the communication processing sections 51, 52 (S104).

The data processing section management sections 513, 523 monitor the registration content as a data processing section registration management table (not shown in the figure).

Under the suchlike state, when the mobile station communication apparatus 2 enters into a communication area of the base station communication apparatus 1, and communication between the mobile station communication apparatus 2 and the base station communication apparatus 1 is initiated, a transmission inquiry is initiated by the two-way communication sections 512, 522 of the both communication apparatuses 1, 2, and the data processing section management sections 513, 523 of the communication processing sections 51, 52 mutually exchange the data processing section registration management table through the two-way communication sections 512, 522 (S105).

That is, the data processing section management section 513 of the base station communication apparatus 1 transmits the data processing section registration management table to the mobile station communication apparatus 2 through the two-way communication section 512. Also, the data processing section management section 523 of the mobile station communication apparatus 2 transmits the data processing section registration management table to the base station communication apparatus 1 through the two-way communication sections 512, 522.

Each of the communication apparatuses 1, 2 confirms whether or not types of the data processing sections 41-44 are mutually matched, on the basis of the received data processing section registration management table of the other communication apparatus (S106).

In case that even only one of the data processing sections 41-44 was not matched, any communication is not carried out, and therefore, it is regarded as communication termination, and a link is cut off (S107).

In case that even only one of the data processing section 41-44 was matched, the matched content is newly prepared and applied as a data processing section operation management table in the data processing section management sections 513, 523, and communication is continued.

The two-way communication section 512 of the base station communication apparatus 1 starts transfer of a transmission inquiry request message to the mobile station communication apparatus 2, through the transmitting and receiving section 61 of the base station communication apparatus 1, in order to carry out a transmission inquiry to the mobile station communication apparatus 2 (S108).

The two-way communication section 522 of the mobile station communication apparatus 2, when it receives the transmission inquiry request message from the base station communication apparatus 1 through the transmitting and receiving section 62 of the mobile station communication apparatus 2 (S109), if data from the application sections 33, 34 has been transferred to the communication processing section 52 from the application data transfer sections 431, 441 of the data processing sections 43, 44 (S110), adds data from the application sections 33, 34 to a transmission inquiry response message, and sends it back to the base station communication apparatus 1 through the transmitting and receiving section 62 (S111).

On one hand, in S110, if data from the application sections 33, 34 has not been transferred to the communication section 52 from the application data transfer sections 431, 441 of the data processing sections 43, 44, without adding any data to the transmission inquiry response message, it is sent back to the base station communication apparatus (S112).

By this operation of a transmission inquiry, the mobile station communication apparatus 2 can transmit data to the base station communication apparatus 1 autonomously.

That is, by repeating such an operation that, to the transmission inquiry request message from the base station communication apparatus 1, the transmission inquiry response message is transmitted from the mobile station communication apparatus 2 by adding data according to the necessity, two-way communication is carried out between both of the communication apparatuses 1, 2.

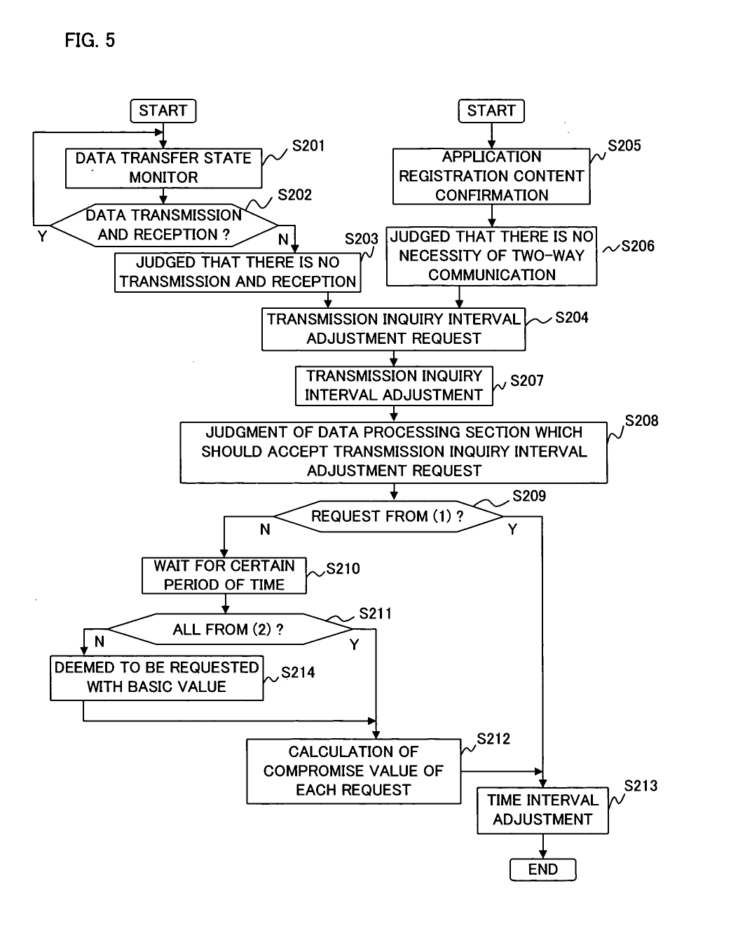

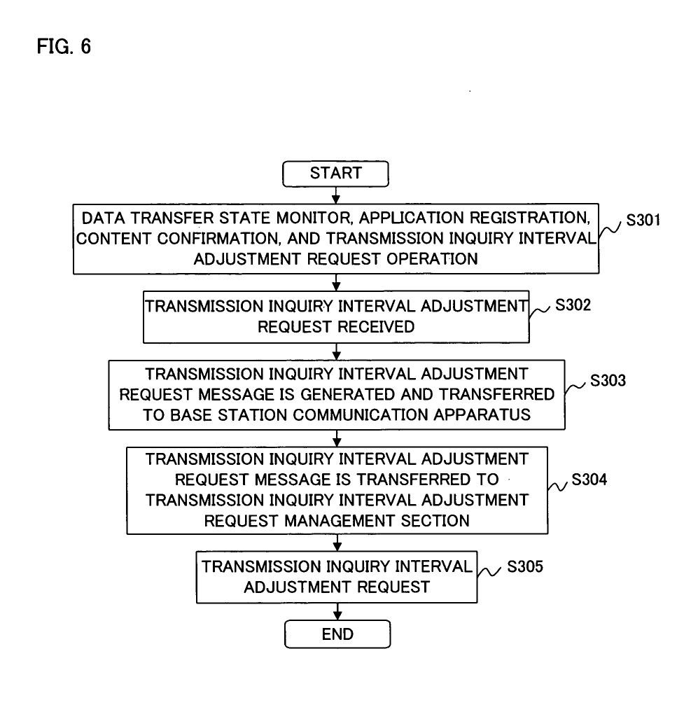

Such an operation that, in this manner, during such a period that two-way communication is carried out between the base station communication apparatus 1 and the mobile station communication apparatus 2, the base station communication apparatus 1 or the mobile station communication apparatus 2 makes a judgment of whether or not the two-way communication is continuously carried out, and in case that it judged that there is no necessity to carry out it continuously, a request of a transmission inquiry from the base station communication apparatus 1 to the mobile station communication apparatus 2 is restricted, will be hereinafter described by use of flow charts of FIGS. 5, 6.

Firstly, in FIGS. 2 and 5, in the data processing section 41 of the base station communication apparatus 1, the data transfer presence or absence judgment section 414 is always monitoring a data transfer state of the application data transfer section 411 (S201). For example, it measures the number of data or an amount of data, which is transmitted and received for a certain period of time, and sets them as statistic data. As a result of monitoring, in case that data transmission and reception are not carried out (N in S202), it is judged that there is no data transmission and reception (S203), and its judgment result is notified to the transmission inquiry interval adjustment request section 413.

Also, in the data processing section 42 of the base station communication apparatus 1, an application registration content, which the application registration acceptance section 425 monitors, is confirmed (S205), and for example, in case that it was judged that there is no necessity of two-way communication, such as a case that the registered application itself does not require two-way communication, and simply requires broadcast communication (S206), its judgment result is notified to the transmission inquiry interval adjustment request section 423.

The transmission inquiry interval adjustment request sections 413, 423 ask the transmission inquiry interval adjustment request management section 514 of the communication processing section 51 for a transmission inquiry interval adjustment request, on the basis of the notified judgment result, i.e., such a notification that there is no necessity of two-way communication any more (S204).

In passing, each data processing section 41, 42 may be configured so as to be able to request adjustment of a transmission interval, directly to the transmission inquiry interval adjustment request sections 413, 423 from the application sections 31, 32. In that case, the application sections 31, 32 are to request it to the data processing sections 41, 42, at such time point that it was judged that there is no necessity of communication.

The transmission inquiry interval adjustment request management section 514 of the communication processing section 51 accepts the transmission inquiry interval adjustment request from the transmission inquiry interval request section 413, 423 of each data processing section 41, 42, and receives a data processing section operation management table from the data processing section management section 513, and takes hold of the data processing sections 41, 42 which are currently operating, and adjusts an interval of a transmission inquiry (S207).

After that, on the basis of the data processing section operation management table, it judges the data processing sections 41, 42 which should accept the transmission inquiry interval adjustment request (S208).

Here, as the data processing sections 41, 42, the following 3 types are considered.

(1) A data processing section which should immediately transmit a content to be adjusted, to the transmission inquiry interval adjustment section 515, if the transmission inquiry interval adjustment request management section 514 receives the transmission inquiry interval adjustment request.

(2) A data processing section which should transmit a content to be adjusted, to the transmission inquiry interval adjustment section 515, after waiting for an request from another transmission inquiry interval adjustment request section, even if the transmission inquiry interval adjustment request management section 514 receives the transmission inquiry interval adjustment request.

(3) A data processing section which does not transmit the transmission inquiry interval request.

In this embodiment, it is described as such a specification that it is clear that types of the data processing sections 41, 42 are any one of the above-described (1)-(3), but such a specification that a type of (1)-(3) is declared at the time of registration to the data processing management sections 412, 422, may be used.

Next, the transmission inquiry interval adjustment request management section 514, when it accepts the transmission inquiry interval adjustment request from the transmission inquiry interval adjustment request sections 413, 423, firstly judges whether a data processing section which is currently operating is of the type (1) or not (S209), and in case that it accepted the transmission inquiry interval adjustment request from the data processing section of the type (1) (Y of S209), it informs a content of an adjustment which is requested by the accepted transmission inquiry interval adjustment request, to the transmission inquiry interval adjustment section 515.

Also, in case that a data processing section which is currently operating is not of the type (1) in S209 (N of S209), the transmission inquiry interval adjustment request is awaited for a certain period of time (S210), and if all of the awaited transmission inquiry interval adjustment requests came from a data processing section of the type (2) (Y of S211), a compromise value of an adjustment interval which is requested by each transmission inquiry interval adjustment request is calculated (S212).

In S210, in case that there was a data processing section which did not make a transmission inquiry interval adjustment request (N of S211), as a result of the transmission inquiry interval adjustment request being awaited for a certain period of time in S210, requests from these data processing sections which did not make transmission inquiry interval adjustment requests are deemed to be requested with a predetermined value before adjustment (S214), and a compromise value of each request is calculated (S212).

For calculation of the compromise value, for example, cutoff of a request value integer average value is adopted, but the invention is not limited to this method.

As above, after the compromise value of each request was calculated in S212, for the purpose of adjusting a transmission inquiry interval, a content to be adjusted is notified to the transmission inquiry interval adjustment section 515.

The transmission inquiry interval adjustment section 515 of the base station communication apparatus 1, which received the content to be adjusted adjusts a transmission inquiry time interval on the basis of the received numerical value (S213).

A content to be requested to the transmission inquiry interval adjustment section 515 is a numerical value of for example, 1 through 4095. This value is set with a unit of millisecond, as a transmission inquiry interval to be adjusted by the transmission inquiry interval adjustment section 515. In case that a transmission inquiry of the base station communication apparatus 1 can not be adjusted with the above-described calculated time interval, a proximate adjustable value is utilized. That value may be calculated by rounding, and may be calculated by cutoff.

In passing, a content to be requested to the transmission inquiry interval adjustment section 515 is not limited to the above-described one, and may be a designation such as “1=maximize an interval, 2=minimize an interval”, and “1=enlarge an interval more, 2=lessen an interval more”. For example, in case of the former, it is possible to set as 1=2000 milliseconds and 2=200 milliseconds.

A transmission inquiry interval is controlled by the transmission inquiry interval adjustment section 515 with respect to each mobile station communication apparatus 2.

Next, a transmission inquiry interval adjustment request operation from the data processing section 43 of the mobile station communication apparatus 2, and a transmission inquiry interval adjustment request operation from the data processing section 44 of the mobile station communication apparatus 2 will be described by use of FIGS. 3 and 6.

A transmission inquiry interval adjustment is requested from the transmission inquiry interval adjustment request sections 433, 443 of the data processing sections 43, 44 of the mobile station communication apparatus 2 to the transmission inquiry interval adjustment request management section 524 of the communication processing section 52, and the transmission inquiry interval adjustment request management section 524 transmits a content to be adjusted, to a transmission inquiry interval adjustment request message generation section 526, on the basis of a data processing section operation management table of the data processing section management section 523. Since operations up to here are the same as operations (S201-S206) of each section of the base station communication apparatus 1, its description will be omitted (S301).

After that, in the mobile station communication apparatus 2, the transmission inquiry interval adjustment request message generation section 526 receives a transmission inquiry interval adjustment request from the transmission inquiry interval adjustment request management section 524, and generates a transmission inquiry interval adjustment request message.

That is, the transmission inquiry interval adjustment request management section 524 of the communication processing section 52, when it receives a transmission inquiry interval adjustment request from the transmission inquiry interval adjustment request sections 433, 443 of the data processing sections 43, 44 of the mobile station communication apparatus 2 (S302), generates a transmission inquiry interval adjustment request message on the basis of a content which was received.

The data processing sections 43, 44 are composed of data processing sections of 3 types of (1)-(3), in the same manner as the data processing sections 41, 42. In case that a transmission inquiry interval adjustment request was received from the data processing section of the type (1), and in case that transmission inquiry interval adjustment requests were received from all data processing sections of the type (2), the transmission inquiry interval adjustment request message generation section 526 of the communication processing section 52 generates a message of a transmission inquiry interval adjustment request.

In passing, in the same manner as the above-described operation of the base station communication apparatus, requests of data from all data processing sections of the type (2) may be judged after awaiting for a certain period of time, and another method may be applicable such as permanently waiting until all data processing sections request the data.

After that, the message which was generated by the transmission inquiry interval adjustment request message generation section 526 is transferred to the base station communication apparatus 1 through the transmitting and receiving section 62, passing through the two-way communication section 522 (S303).

The transmitting and receiving section 61 of the base station communication apparatus 1, when it receives a transmission inquiry interval adjustment request message from the mobile station communication apparatus 2, transfers it to the transmission inquiry interval adjustment request management section 514 through the two-way communication section 512 (S304).

The transmission inquiry interval adjustment request management section 514 of the base station communication apparatus 1 interprets a content of the transmission inquiry interval adjustment request message from the mobile station communication apparatus 2, and requests to the transmission inquiry interval adjustment section 515 an adjustment of a transmission inquiry interval (S305).

In passing, a method for matching requests of the data processing sections 41, 42 of the base station communication apparatus 1, and the data processing sections 43, 44 of the mobile station communication apparatus 2 in all may be used. In this case, the mobile station communication apparatus 2 operates in a slightly different manner as follows.

Even in such a state that the transmission inquiry interval adjustment request management section 524 of the mobile station communication apparatus 2 receives, for example, an adjustment request from the transmission inquiry interval adjustment request section 433 of one data processing section 43, and the transmission inquiry interval adjustment request section 443 of the data processing section 44, which has not yet received an adjustment request, is remained, a transmission inquiry interval adjustment request is transmitted to the base station communication apparatus 1. To a transmission inquiry interval adjustment request message, a data processing section identifier is added so as to show from which data processing section it was received.

The base station communication apparatus 1 judges that it received a transmission inquiry interval adjustment request from a data processing section of the type (1) or all data processing sections of the type (2), in substitution for a request from the data processing section 44 with a request from the data processing section 42 of an own station, on the basis of transmission inquiry interval adjustment requests from the data processing sections 41, 42, and the received transmission inquiry interval adjustment request message to which a data processing section identifier was added from the mobile station communication apparatus 2, and requests to the transmission inquiry interval adjustment section 515 an adjustment of a transmission inquiry interval.

By the above-described operations, it becomes possible to adjust a transmission inquiry interval.

According to the communication system of one embodiment of the invention, by disposing a transmission inquiry interval adjustment request section in a data processing section, by disposing a transmission inquiry interval adjustment request management section and a transmission inquiry interval adjustment section in a communication processing section of a base station communication apparatus, and by disposing a transmission inquiry interval adjustment request management section and a transmission inquiry adjustment request message generation section in a mobile station communication apparatus, it is possible to eliminate such a problem that communication between the base station communication apparatus and the mobile station communication apparatus is consumed uselessly.

2. Second Exemplary Embodiment

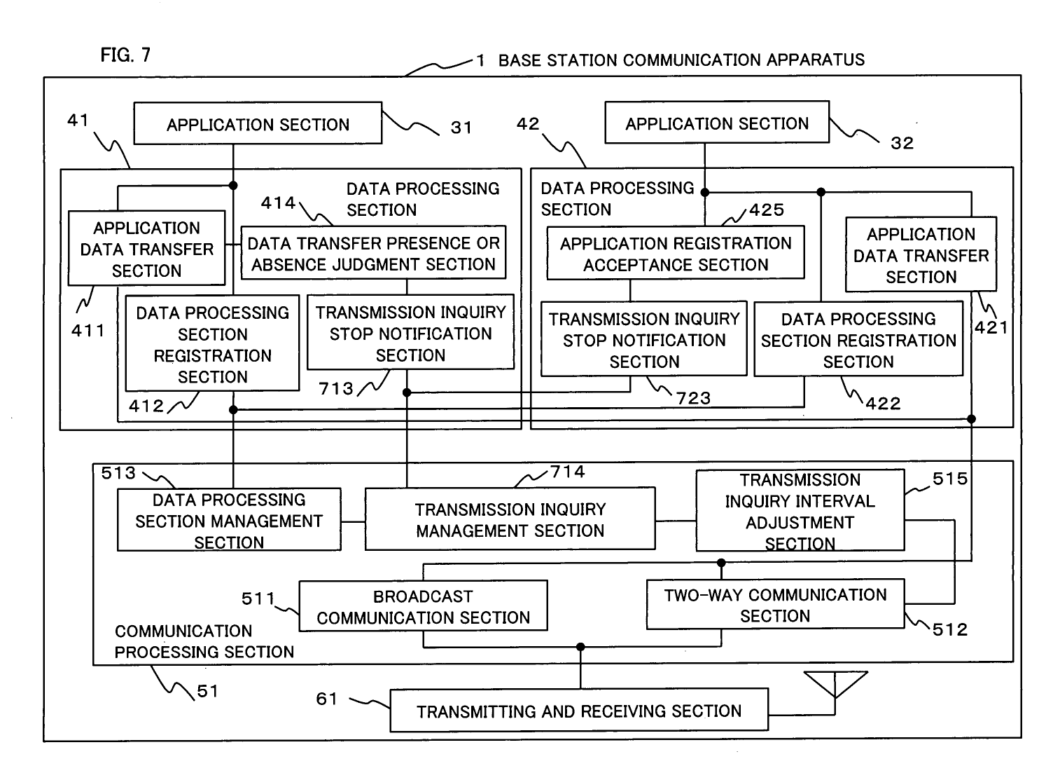

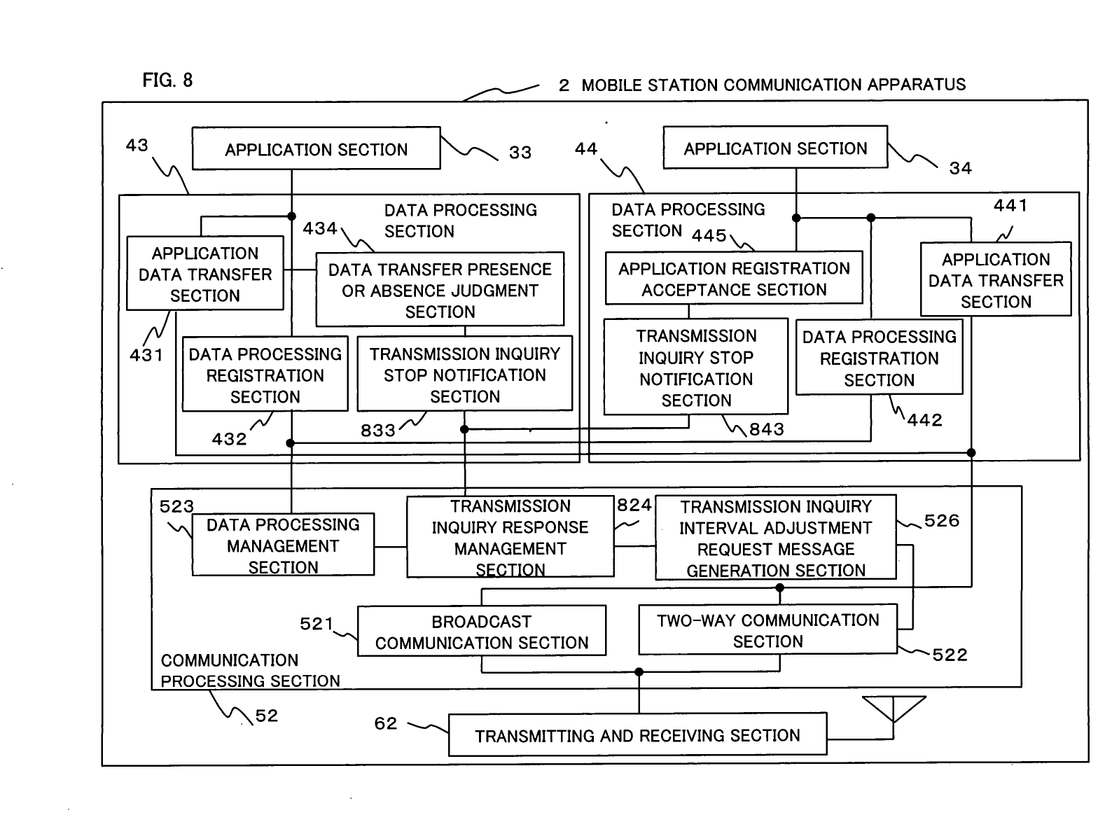

FIG. 7 is a block diagram of a base station communication apparatus of the communication system of this embodiment, and FIG. 8 is a block diagram of a mobile station communication apparatus of the same embodiment.

In an explanation of this embodiment, as to the same constituent elements as in the first embodiment, an explanation will be omitted by giving the same numbers to them.

A difference between this embodiment and the first embodiment is on such a point that, as to the base station communication apparatus, in substitution for the transmission inquiry interval adjustment request sections 413, 423 of the data processing sections 41, 42 in the first embodiment, in this embodiment, transmission inquiry stop notification sections 713, 723 are used, and in substitution for the transmission inquiry interval adjustment management section 514 of the communication processing section 51, a transmission inquiry management section 714 is used.

Also, as to the mobile station communication apparatus 2, in substitution for the transmission inquiry interval adjustment request sections 433, 443 in the first embodiment, in this embodiment, transmission inquiry stop notification sections 833, 843 are used, and in substitution for the transmission inquiry interval adjustment request response section 524, a transmission inquiry response management section 824 is used.

That is, the transmission inquiry stop notification section 713 of the data processing section 41 of the base station communication apparatus 1 notifies a stop of a transmission inquiry to the transmission inquiry management section 714 of the communication processing section 51, on the basis of a judgment result in the data transfer presence or absence judgment section 414. Also, the transmission inquiry stop notification section 723 notifies a stop of a transmission inquiry to the transmission inquiry management section 714 of the communication processing section 51, in accordance with a type of an application which was registered in the application registration acceptance section 425.

The transmission inquiry management section 714 of the communication processing section 51 instructs the transmission inquiry interval adjustment section 515 to stop a transmission inquiry for two-way communication which is carried out to the mobile station, on the basis of the notifications from the transmission inquiry stop notification sections 713, 723.

Also, the transmission inquiry response management section 824 of the communication section 52 of the mobile station communication apparatus 2, when it receives a request of a transmission inquiry stop from the transmission inquiry stop notification sections 833, 843 of the data processing sections 43, 44, instructs the transmission inquiry interval adjustment request message generation section 526 to generate a message of a transmission inquiry stop notification, on the basis of its content.

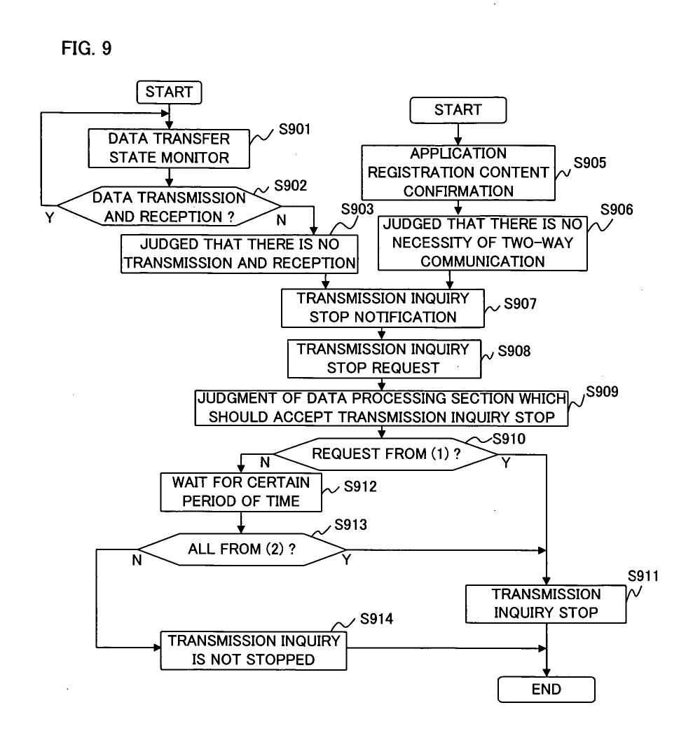

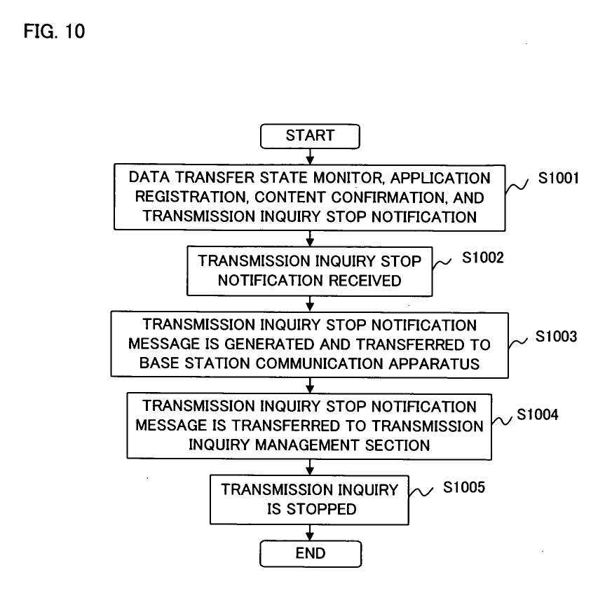

The communication system of this embodiment, which was configured as above will be described as to its operation by use of flow charts of FIGS. 9 and 10.

Operations from activation of the base station communication apparatus 1 and the mobile station communication apparatus 2 until the mobile station communication apparatus 2's reception of a transmission inquiry request from the base station communication apparatus 1 are the same as in the first embodiment, which were described in FIG. 4.

In this embodiment, as described below, a stop of two-way communication is notified to the mobile station communication apparatus 2, on the basis of judgments of the transmission inquiry stop notification sections 713, 723 of the data processing section 41 of the base station communication apparatus 1.

In FIGS. 7 and 9, in the data processing section 41 of the base station communication apparatus 1, in the same manner as in the first embodiment, the data transfer presence or absence judgment section 414 is always monitoring a data transfer state of the application data transfer section 411 (S901). As a result of monitoring, since data transmission and data reception are not carried out (N of S902), and it is judged that there is no data transmission and data reception (S903), and its judgment result is notified to the transmission inquiry stop notification section 713 (S907).

Also, in the data processing section 42 of the base station communication apparatus 1, in the same manner as in the first embodiment, a registration content of an application which the application registration acceptance section 425 manages is confirmed (S905), and in case that it was judged that there is no necessity of two-way communication (S906), its judgment result is notified to the transmission inquiry stop notification section 723 (S907).

The transmission inquiry stop notification sections 713, 723 ask the transmission inquiry management section 714 of the communication processing section 51 for a transmission inquiry stop, on the basis of such a notification that there is no necessity of two-way communication any more (S908).

In passing, it may be configured that each data processing section 41, 42 can notify a stop of a transmission inquiry, directly to the transmission inquiry stop notification sections 713, 723, from the application sections 31, 32. In that case, the application sections 31, 32 are to make requests to the data processing sections 41, 42 at such a time point that it was judged that there is no necessity of communication.

The transmission inquiry management section 714 of the communication processing section 51 accepts a transmission inquiry stop notification from the transmission inquiry stop notification sections 713, 723 of each data processing section 41, 42, and receives a data processing section operation management table from the data processing section management section 513, and takes hold of the data processing sections 41, 42 which are currently operating.

After that, on the basis of the data processing section operation management table, the data processing sections 41, 42, which should accept a transmission inquiry interval adjustment request, are judged (S909).

Here, as described in the first embodiment, as the data processing sections 41, 42, the following 3 types are considered.

(1) A data processing section which should immediately transmit a content to be stopped, to the transmission inquiry interval adjustment section 515, if the transmission inquiry management section 714 receives the transmission inquiry stop notification.

(2) A data processing section which should transmit a content to be stopped, to the transmission inquiry interval adjustment section 515, after waiting for a stop notification from another transmission inquiry stop notification section, even if the transmission inquiry management section 714 receives the transmission inquiry stop notification.

(3) A data processing section which is understood not to transmit the transmission inquiry stop notification.

In this embodiment, it is described as such a specification that it is clear that types of the data processing sections 41, 42 are any one of the above-described (1)-(3), but such a specification that a type of (1)-(3) is declared at the time of registration to the data processing management sections 412, 422, may be used.

Next, the transmission inquiry management section 714, when it accepts the transmission inquiry stop notification from the transmission inquiry stop notification sections 713, 723, firstly judges whether a data processing section which is currently operating is of the type (1) or not (S909), and in case that it accepted the transmission inquiry stop notification from the data processing section of the type (1) (Y of S910), it informs a content of the received transmission inquiry stop notification to the transmission inquiry interval adjustment section 515, and stops a transmission inquiry (S911).

Also, in S910, in case that a data processing section which is currently operating is not of the type (1) (N of S910), a transmission inquiry stop notification is awaited for a certain period of time (S912), and in case that all of the awaited transmission inquiry stop notifications came from the data processing sections of the type (2) (Y of S913), a stop of a transmission inquiry is notified to the transmission inquiry interval adjustment section 515, and the transmission inquiry is stopped (S911)

In S912, in case that there was a data processing section which did not make a transmission inquiry stop notification, as a result of awaiting a transmission inquiry stop notification for a certain period of time (N of S913), a transmission inquiry is not stopped (S914).

In passing, in S912, in case that there was a data processing section which does not make a transmission inquiry stop notification, for a rather long certain period of time, it may be judged to make a transmission inquiry stop notification, and a transmission inquiry stop may be made.

In passing, with regard to a data processing section like the type (3), it is not made to be an objet for consideration, and for example, it may be judged that there was a transmission inquiry stop request, and may be judged that there is not.

Also, as to such a matter that the transmission inquiry stop notification is managed with respect to each mobile station communication apparatus, and so on, they are the same as in the first embodiment.

Next, a transmission inquiry stop notification operation from the data processing section 43 of the mobile station communication apparatus 2, and a transmission inquiry stop notification operation from the data processing section 44 of the mobile station communication apparatus 2 will be described by use of FIGS. 8 and 10.

A transmission inquiry stop notification is requested from the transmission inquiry stop notification sections 833, 843 of the data processing sections 43, 44 of the mobile station communication apparatus 2 to the transmission inquiry response management section 824 of the communication processing section 52, and the transmission inquiry response management section 824 transmits a content to be stopped, to a transmission inquiry interval adjustment request message generation section 526, on the basis of a data processing section operation management table of the data processing section management section 523. Since operations up to here are the same as operations (S901-S907) of each section of the base station communication apparatus 1, description will be omitted (S1001).

After that, in the mobile station communication apparatus 2, the transmission inquiry interval adjustment request message generation section 526 receives a transmission inquiry stop notification from the transmission inquiry response management section 824, and generates a transmission inquiry interval adjustment request message which shows the transmission inquiry stop notification.

That is, the transmission inquiry response management section 824 of the communication processing section 52, when it receives a transmission inquiry stop notification from the transmission inquiry stop notification sections 833, 843 of the data processing sections 43, 44 of the mobile station communication apparatus 2 (S1002), generates a transmission inquiry interval adjustment request message which shows the transmission inquiry stop notification, on the basis of a content which was received.

The data processing sections 43, 44 are composed of data processing sections of 3 types of (1)-(3), in the same manner as the data processing sections 41, 42 of the base station communication apparatus 1, and carry out the same operations as those of the base station communication apparatus 1.

That is, in case that a transmission inquiry stop notification was received from the data processing section of the type (1), and in case that transmission inquiry stop notifications were received from all data processing sections of the type (2), the transmission inquiry adjustment request message generation section 526 of the communication processing section 52 generates a message of a transmission inquiry stop notification.

After that, the transmission inquiry stop notification message which was generated by the transmission inquiry interval adjustment request message generation section 526 is transferred to the base station communication apparatus 1 through the transmitting and receiving section 62, passing through the two-way communication section 522 (S1003).

The transmitting and receiving section 61 of the base station communication apparatus 1, when it receives a transmission inquiry stop notification message from the mobile station communication apparatus 2, transfers it to the transmission inquiry management section 714 through the two-way communication section 512 (S1004).

The transmission inquiry management section 714 of the base station communication apparatus 1 interprets a content of the transmission inquiry stop notification message from the mobile station communication apparatus 2, and instruct to stop a transmission inquiry to the transmission inquiry interval adjustment section 515 (S1005).

In passing, in the same manner as in the first embodiment, a method for matching requests of the data processing sections 41, 42 of the base station communication apparatus 1, and the data processing sections 43, 44 of the mobile station communication apparatus 2 in all may be used.

As above, by stopping a transmission inquiry, it is possible to restrict two-way communication between abase station and a mobile station.

According to the communication system of the second embodiment, as described above, by disposing a transmission inquiry stop notification section in a data processing section, by disposing a transmission inquiry management section in a data processing section of a base station communication apparatus, and by disposing a transmission inquiry response management section in a mobile station communication apparatus, it is possible to eliminate such a problem that communication between the base station communication apparatus and the mobile station communication apparatus is consumed uselessly.

In passing, according to the invention, in case that a mobile station is such as a vehicle, restricting two-way communication by stopping a transmission inquiry in case that broadcast communication is going on makes a big advantage since a mobile station cannot obtain various data from a base station when the mobile station is not receiving any signal from the base station.

Also, the invention gives a bigger advantage when it is applied to a time division multiplex communication system in which influence is given to a communication band of another station as vehicles are increased, i.e. data amount is increased.

Further, in the above-described embodiments, described was such a case that a mobile station is a vehicle, but needless to say, the invention is not limited to this, and is applicable to such a communication system with a narrow range, in which a navigation apparatus is a base station, in one vehicle, and a portable telephone, a digital camera, or the like is a mobile station in the same vehicle.

The invention has such an advantage that it is possible to eliminate waste in communication efficiency, by having a broadcast communication unit adapted to transmit data in a single direction from a base station to a mobile station, a two-way communication unit adapted for the mobile station to transmit data to the base station in accordance with at least one time transmission inquiry request from the base station to the mobile station, a judgment unit disposed in the base station or the mobile station and adapted to judge whether or not the two-way communication is carried out continuously, and a restriction unit adapted to restrict a transmission inquiry request from the base station to the mobile station, in case that the judgment unit judged that there is no necessity to continuously carry out the two-way communication.

Also, a base station of the invention has such an advantage that it is possible to eliminate a waste of communication efficiency, by being a base station communicating with a mobile station through broadcast communication and two-way communication, and by having a two-way communication unit adapted to transmit data to the mobile station, to which the mobile station can transmit the data in accordance with a transmission inquiry request, a broadcast communication unit adapted to carry out broadcast communication with the mobile station, and a two-way communication restriction unit adapted to restrict the transmission inquiry request to the mobile station, on the basis of such a judgment in the base station or the mobile station that there is no necessity to continuously carry out the two-way communication.

Further, a mobile station of the invention has such an advantage that it is possible to eliminate a waste of communication efficiency, by being mobile station communicating with a base station through broadcast communication or two-way communication, and by having a two-way communication unit which can transmit data to the base station in accordance with a transmission inquiry request from the base station, a broadcast communication unit adapted to carry out broadcast communication with the base station, and a judgment unit adapted to carry out a judgment of whether or not the two-way communication is carried out continuously, and by having such a configuration that the two-way communication unit transmits a request for restricting the transmission inquiry to the base station, in case that the judgment unit judged that there is no necessity to continuously carry out the two-way communication, and the base station restricts the two-way communication on the basis of the request for restricting the transmission inquiry.

1. A communication system comprising:
a broadcast communication unit adapted to transmit data in a single direction from a base station to a mobile station;
a two-way communication unit adapted for said mobile station to transmit data to said base station in accordance with at least one time transmission inquiry request from said base station to said mobile station;
a judgment unit disposed in said base station or said mobile station and adapted to judge whether or not said two-way communication is carried out continuously; and
a restriction unit adapted to restrict a transmission inquiry request from said base station to said mobile station, in case that said judgment unit judged that there is no necessity to continuously carry out said two-way communication.

2. The communication system as set forth in claim 1, wherein restriction of the transmission inquiry from said base station to said mobile station by said restriction unit is carried out in case that, in such a state that said broadcast communication is continued, it was further judged that there is no necessity to continuously carry out said two-way communication.

3. The communication system as set forth in claim 1, wherein restriction of the transmission inquiry from said base station to said mobile station by said restriction unit is restriction of the number of times as to the transmission inquiry request from said base station to said mobile station.

4. The communication system as set forth in claim 1, wherein restriction of the transmission inquiry from said base station to said mobile station by said restriction unit is a stop of the transmission inquiry request from said base station to said mobile station.

5. The communication system as set forth in claim 1, wherein restriction of the transmission inquiry from said base station to said mobile station by said restriction unit is judged by said base station or said mobile station on the basis of a type of an application for processing said data.

6. The communication system as set forth in claim 1, wherein restriction of the transmission inquiry from said base station to said mobile station by said restriction unit is judged by said base station or said mobile station in accordance with an amount of said data to be processed.

7. The communication system as set forth in claim 1, wherein said broadcast communication and said two-way communication are carried out by a time division communication system.

8. The communication system as set forth in claim 1, wherein, in case that at least any one of said broadcast communication and said two-way communication is carried out, restriction of the transmission inquiry request from said base station to said mobile station is carried out by said restriction unit.

9. The communication system as set forth in claim 1, wherein restriction of the transmission inquiry request from said base station to said mobile station by said restriction means in case that said two-way communication is carried out is restriction of the number of times as to the transmission inquiry request from said base station to said mobile station.

10. A base station communicating with a mobile station through broadcast communication or two-way communication, comprising:
a two-way communication unit adapted to transmit data to said mobile station, to which said mobile station can transmit said data in accordance with a transmission inquiry request;
a broadcast communication unit adapted to carry out broadcast communication with said mobile station; and
a two-way communication restriction unit adapted to restrict the transmission inquiry request to said mobile station, on the basis of such a judgment in said base station or said mobile station that there is no necessity to continuously carry out said two-way communication.

11. A mobile station communicating with a base station through broadcast communication or two-way communication, comprising:
a two-way communication unit which can transmit data to said base station in accordance with a transmission inquiry request from said base station;
a broadcast communication unit adapted to carry out broadcast communication with said base station; and
a judgment unit adapted to carry out a judgment of whether or not said two-way communication is carried out continuously,
wherein said two-way communication unit transmits a request for restricting the transmission inquiry request to said base station, in case that said judgment unit judged that there is no necessity to continuously carry out said two-way communication, and said base station restricts said two-way communication on the basis of the request for restricting said transmission inquiry.

12. The communication system as set forth in claim 2, wherein restriction of the transmission inquiry from said base station to said mobile station by said restriction unit is restriction of the number of times as to the transmission inquiry request from said base station to said mobile station.

13. The communication system as set forth in claim 2, wherein restriction of the transmission inquiry from said base station to said mobile station by said restriction unit is a stop of the transmission inquiry request from said base station to said mobile station.

14. The communication system as set forth in claim 2, wherein restriction of the transmission inquiry from said base station to said mobile station by said restriction unit is judged by said base station or said mobile station on the basis of a type of an application for processing said data.

15. The communication system as set forth in claim 2, wherein restriction of the transmission inquiry from said base station to said mobile station by said restriction unit is judged by said base station or said mobile station in accordance with an amount of said data to be processed.

16. The communication system as set forth in claim 2, wherein said broadcast communication and said two-way communication are carried out by a time division communication system.

17. The communication system as set forth in claim 2, wherein, in case that at least any one of said broadcast communication and said two-way communication is carried out, restriction of the transmission inquiry request from aid base station to said mobile station is carried out by said restriction unit.

18. The communication system as set forth in claim 2, wherein restriction of the transmission inquiry request from said base station to said mobile station by said restriction means in case that said two-way communication is carried out is restriction of the number of times as to the transmission inquiry request from said base station to said mobile station.
